(19) United States
(12) Patent Application Publication
(10) Pub. No.: US 2020/0406187 A1
(43) Pub. Date: Dec. 31, 2020

(54) Method for Purifying a Gaseous, Liquid or Aerosol Composition Containing at Least One Polluant

(71) Applicant: Philippe David, Saint Georges-sur-Fontaine (FR)

(72) Inventor: Philippe David, Saint Georges-sur-Fontaine (FR)

(21) Appl. No.: 16/481,091

(22) PCT Filed: Jan. 25, 2018
(86) PCT No.: PCT/IB2018/000033

§ 371 Date: Sep. 10, 2019

(30) Foreign Application Priority Data
Jan. 26, 2017 (FR) 1750652

(51) Int. Cl. B01D 53/78; B01D 53/52

(52) U.S. Cl. CPC B01D 53/78; B01D 53/526; B01D 2257/553; B01D 2257/504; B01D 2257/404; B01D 2258/05; B01D 2257/302; B01D 2257/406; B01D 2257/204; B01D 2252/205; B01D 2252/10; B01D 2257/304

(57) ABSTRACT

The invention relates to a method for purifying a gaseous, liquid or aerosol composition, containing at least one pollutant consisting of a volatile inorganic compound (VIC), a siloxane and/or a functional volatile organic compound (Pollution Trap Concept or P.T.C. System).

The invention relates to a method for purifying a gaseous, liquid or aerosol composition, containing at least one pollutant consisting of a volatile inorganic compound (VIC), a siloxane, and/or a functional volatile organic compound (VOC).

The emission of atmospheric pollutants is regulated by law, due to the negative impact thereof, in particular on human health, biological resources, ecosystems and climate.

These pollutants can be Volatile Organic compounds (VOC), and/or greenhouse gases.

World emissions of VOC have been estimated at about a billion tonnes during the year 2000. They come, for 90% of them, from natural sources (biological fermentations, natural gas leaks) and for 10%, from anthropogenic sources (coming from human activities). The emissions of natural origin are uniformly distributed on the surface of the Earth. However, the anthropogenic emissions come mostly from industrialised countries.

VOCs can cause eye and throat irritations, allergies, headaches, asthma attacks, nausea, etc.

Certain VOCs also play an important role in the troposphere, leading to an increase in the quantity of ozone in the air. Ozone is produced, among others, from nitrogen dioxide under the effect of solar radiation. The ozone formed then reacts with nitrogen monoxide to produce nitrogen dioxide. But, in the presence of VOC, the preceding cycle is modified by the carbon radicals (powerful oxidants) that substitute for the ozone during the reaction of the formation of the nitrogen dioxide, which leads to an increase in the quantity of ozone. The increase in the quantity of ozone, with the consequences thereof on the environment and on health, is therefore partially linked to the discharges of VOC.

Moreover, the concentrations in greenhouse gases in the Earth's atmosphere have been increasing since the 19th century for substantially anthropogenic reasons with a new record in 2014 according to the World Meteorological Organisation (WMO). The increase in the main greenhouse gases is mainly due to certain human activities, including the massive use of fossil fuels (coal, oil).

Greenhouse gases, such as carbon dioxide (which represents nearly 70% of the greenhouse gas emissions of anthropogenic origin) and methane, are not necessarily directly dangerous for humans, biological resources and ecosystems, but the emissions thereof are at the origin of global warming, a phenomenon which has many harmful effects for humans and their environment.

In this context, the treatment of gaseous effluents, wastewater and sludge, as well as the valorisation of domestic, industrial and agricultural organic residues, are certainly of interest from a political, economic and environmental standpoint.

With regards to the treatment of gaseous effluents, the conventional methods use in particular oxidants, such as Javel water. However, these oxidising washing methods have the major disadvantage of generating in the discharges, oxidation by-products, which themselves are pollutants and sometimes very strongly odoriferous. Furthermore, these oxidants are unstable and handling them is dangerous.

With regards to the valorisation of domestic, industrial and agricultural organic wastes, the integration of biogas into the French energy landscape makes it possible in particular for a considerable decrease in the discharged greenhouse gases. Said biogas is a combustible gas obtained by fermentation, also called methanisation, of animal or plant organic wastes in the absence of oxygen, which mostly comprises methane as well as carbon dioxide.

Indeed, as the greenhouse effect of methane is 20 to 25 times greater than that of carbon dioxide, it is preferable to valorise biogas as a renewable source of energy, rather than discharge it into the atmosphere.

The recent fluctuations in costs linked to importing fossil fuels, in a context of depletion of these fossil fuels, also have favourably influenced the regain in economic interest for the production of energy from biogas.

Biogas is valorised in different ways. It can, after a slight treatment, be valorised in the vicinity of the production site to provide heat, electricity or a mixture of the two (the substantial carbon dioxide content reduces the calorific power of the biogas, increases the compression and transport costs and consequently limits the economic interest in the valorisation of biogas far from the production site).

Biogas can also be purified in order to make it possible for wider use. In particular, biogas can be subjected to a purification that consists of eliminating from the raw biogas, the undesirable substances and the traces of pollutants (ammonia, sulphur compounds, VOCs including organochlorines, siloxanes) and increasing the methane content thereof (in particular by removing CO₂) to produce a gas comparable to natural gas. The biogas thus purified and enriched is called biomethane, and has a calorific power equivalent to that of natural gas. Purified biogas is also the precursor of the biohydrogen obtained via steam cracking.

Indeed, research over the last ten years on the subject has highlighted the disadvantages of VOCs and in certain cases of siloxanes, present in biogases, on the running of energy operation facilities.

Regardless of the recovery route used, the presence of these compounds at concentrations of the order of ppm leads to a risk of premature degradation of the facilities, as well as a depreciation in the energy valorisation yield of the biogas.

For example, in the case of use of biogas as an engine fuel, it is necessary to remove the siloxane compounds because, oxidised at high temperatures, the siloxanes form silica deposits that can seriously damage the equipment.

The purification of biogas is generally carried out according to the following methods:
pressure swing adsorption (PSA): the method uses an adsorbent (molecular filters or zeolites). This method is, however, very complex (in particular due to the necessity of working under pressure) and has the disadvantage of releasing the CO₂ into the atmosphere at the end of the treatment cycle and of generating a loss of biomethane in the form of vents (or “offgas”);
washing with water: this method of washing with water involves a pressurised water washing tower, a degassing tower and a desorption tower;
physical absorption with an organic solvent: this method is similar to that of washing with water, with the solvent being in this case an organic fluid, in particular glycols, amino-alcohols or amines. However, this method requires regenerating the solvent;
membrane separation: membrane separation operates like a filter. This method is however complex due the need to work under pressure, and has the disadvantage of releasing the CO₂ into the atmosphere at the end of the treatment cycle.

A method has now been developed for purifying a gaseous, liquid or aerosol composition, comprising a step of alkalinisation and a step of putting into contact with a compound of formula (I) such as defined below, advantageously making it possible to overcome the aforementioned disadvantages.

This method furthermore offers several advantages.

Firstly, the method according to the invention makes it possible for “one-pot” treatment, of any pollutant, alone or in a multi-pollutant mixture, selected from volatile inorganic compounds (carbon dioxide, nitrogen monoxide, nitrogen dioxide, halogenhydric acids, thionyl chloride, sulphuryl chloride, ammonia, halogens, hydrogen sulphide, carbon oxysulphide and sulphur dioxide), siloxanes and functional volatile organic compounds, and this, in particular on one single washing tower.

When the gaseous composition is a biogas, the method makes possible, in a single operation, for the capture of the CO₂ but also of all of the aforementioned pollutants, when they are present in the biogas.

Moreover, the CO₂ thus treated can advantageously be recovered, in particular in the form of carbonate, which can be valorised in particular in a cement plant.

Furthermore, the method according to the invention is simple to implement, and is easily integrated into the systems in place, for example without it being necessary to modify existing washing towers.

In addition, the method according to the invention is competitive from an economic point of view, in particular for the production of biomethane.

Thus, according to a first aspect, the invention relates to a method for purifying a gaseous, liquid or aerosol composition, containing at least one pollutant consisting of:
at least one volatile inorganic compound (VIC) selected from carbon dioxide, nitrogen monoxide, nitrogen dioxide, halogenhydric acids, thionyl chloride, sulphuryl chloride, ammonia, halogens, hydrogen sulphide, carbon oxysulphide and sulphur dioxide, and/or
at least one siloxane, and/or
at least one functional volatile organic compound (VOC),

said method comprising the following steps:

(i) the alkalinisation of said composition to a pH>11 in the presence of a base of general formula M-OH, wherein M represents an alkaline metal,

(ii) the putting into contact of the product obtained in (i) with a compound of general formula (I):

R—[CH(—X)]ₙ—CO—R¹ (I),

wherein:

R represents:
a sulfonyl halide of formula X′—SO₂—R′, wherein X′ represents a halogen, and R′ represents a C₁-C₂₀ alkyl group or an optionally substituted aryl group,
a halogen, or
an OH group,

X represents:
a halogen,
an OH group,
a hydrogen, or
a COOH group,

R¹ represents:
a C₁-C₁₆ alkoxy,
a group of formula NH—R″, wherein R″ represents a hydrogen atom or a C₁-C₂₀ alkyl group,
a group of formula OR² wherein R² represents a hydrogen atom, an alkaline metal, an alkaline earth metal or an ammonium group, or
a halogen,

n represents 1, 2, 3 or 4;

to obtain a purified composition, as well as a capture product resulting from the reaction of the at least one pollutant with said base and/or said compound of formula (I);

(iii) the separation of said purified composition from said capture product;

with the condition that said pollutant does not consist exclusively of hydrogen sulphide, sulphur dioxide, or a functional volatile organic compound carrying a thiol group.

Thus, only inert gaseous compounds, such as for example so methane, butane, propane, nitrogen, oxygen, are not captured. The method according to the present invention therefore makes it possible to purify gaseous flows that mostly comprise said inert gaseous compounds, alone or in mixtures.

According to a specific embodiment, the pollutant does not consist exclusively of hydrogen sulphide, a functional volatile organic compound carrying a thiol group, or the mixtures thereof.

According to a specific embodiment, the pollutant does not consist exclusively of hydrogen sulphide, carbon oxysulphide, sulphur dioxide, thionyl chloride, sulphuryl chloride, a functional volatile organic compound carrying a thiol, disulphide or thioester group, or the mixtures thereof.

According to a specific embodiment, the pollutant does not consist exclusively of hydrogen sulphide, carbon oxysulphide, sulphur dioxide, thionyl chloride, sulphuryl chloride, a functional volatile organic compound carrying a thiol, disulphide or thioester group, hydrofluoric acid, hydrochloric acid, hydrobromic acid, hydriodic acid, or mixtures thereof.

In particular, the at least one pollutant consists of:
at least one volatile inorganic compound (VIC) selected from carbon dioxide, nitrogen monoxide, nitrogen dioxide, ammonia, halogens, and/or
at least one siloxane, and/or
at least one functional volatile organic compound selected from volatile organic compounds (VOC) carrying an amine, amide, nitrile, aldehyde, ketone, ester, carboxylic acid, alcohol group, halogenated volatile organic compounds, phosgene and hydrocyanic acid.

According to an embodiment, said composition is liquid or in natural aerosol form.

According to a specific embodiment, said composition, when it is liquid, is transformed into an aerosol prior to step (i). This transformation is in particular carried out according to techniques that are well known to a person skilled in the art.

According to a specific embodiment, said composition contains carbon dioxide and at least one other pollutant consisting of:
at least one volatile inorganic compound selected from nitrogen so monoxide, nitrogen dioxide, halogenhydric acids, thionyl chloride, sulphuryl chloride, ammonia, halogens, hydrogen sulphide, carbon oxysulphide and sulphur dioxide, and/or
at least one siloxane, and/or
at least one functional volatile organic compound,

said method comprising the following steps:

(i) the alkalinisation of said composition to a pH>11 in the presence of a base of general formula M-OH such as defined in claim 1,

(ii) the putting into contact of the product obtained in (i) with a compound of general formula (I) such as defined in claim 1,

to obtain a purified composition, as well as a capture product resulting from the reaction of the carbon dioxide and of the at least one other pollutant with the base and/or the compound of formula (I);

(iii) the separation of said purified composition from said capture product.

In particular, the at least one other pollutant consists of:
at least one volatile inorganic compound selected from carbon dioxide, nitrogen monoxide, nitrogen dioxide, ammonia, halogens, and/or
at least one siloxane, and/or
at least one functional volatile organic compound selected from volatile organic compounds carrying an amine, amide, nitrile, aldehyde, ketone, ester, carboxylic acid, alcohol group, halogenated volatile organic compounds, phosgene and hydrocyanic acid.

According to a specific embodiment, said composition is a biogas.

Said biogas comes in particular from the methanisation of industrial or agricultural waste, household waste, sevrage sludge or products of natural hydraulic fracturing and more generally from a biomass thermal treatment.

According to a more specific embodiment, said capture product comprises a first capture product resulting from the reaction of the carbon dioxide with the base, and of a second capture product resulting from the reaction of the at least one other pollutant with the base and/or the compound of formula (I).

According to an even more specific embodiment, the first capture product is separated from the second capture product at the end of the step (iii).

According to a specific embodiment, said composition is a natural gas, obtained in particular by hydraulic fracturing.

Hydraulic fracturing is in particular a technique that makes it possible to release the gas imprisoned in underground rocks. This is then referred to as hydrofracturing or “fracking”.

This can also be natural hydraulic fracturing (or frost weathering), which can be on land or at sea.

The method according to the invention has the advantage of transforming the CO₂ into carbonates. These carbonates are precursors in the chain for manufacturing cement, either by the dry route, or by the wet route.

Advantageously, after said separation, the first capture product is put into contact with calcium chloride to form calcium carbonate.

For example, when M represents Na, the first capture product corresponds mainly to sodium carbonate. The sodium carbonate can then advantageously be displaced by calcium chloride in order to obtain calcium carbonate that is practically insoluble according to the reaction:

Na₂CO₃+CaCl₂→CaCO₃+2NaCl

According to a specific embodiment, said composition is an effluent.

In this case, the method according to the invention has for example application in the following sectors:
petrochemicals,
refining,
steel making, foundries,
hydrocarbon waste treatment industries,
mineral chemistry industries: for example, production of sulphuric acid and titanium oxide,
chemical industries (organic chemistry, fine chemistry),
paper industries,
agri-food industries,
bioenergy (biogas, biomethane and biohydrogen).

According to a specific embodiment, steps (i) and (ii) are carried so out simultaneously.

According to a specific embodiment, steps (i) and (ii) are carried out in a washing tower, in particular in one single washing tower.

The method according to the invention is easily integrated into the systems in place, in particular without it being necessary to modify the existing washing towers.

For example, steps (i) and (ii) can be carried out in a single washing tower. This is then a discontinuous method, called “batch”. The tower can then be emptied, and the liquid effluent drained to a basin for receiving industrial water. The tower can then be refilled for another operation.

Alternatively, the composition to be treated can be sent to a treatment unit comprising generally two to three washing towers. For example, each tower is equipped with at least one recycling pump. The foot of each tower is used as a retention volume and wet well of the recirculation pump of the baths. In each tower, the air is introduced from the bottom up and the washing solutions are sprayed against the current, from top to bottom. This type of facility with 2 or 3 stages is suitable for continuous treatment. Once the first tower has arrived at saturation controlled by pH-metering (in particular pH<9), the flow can be switched to the second tower, and so on.

The technologies most often used are packing columns, spray towers and atomisation, and horizontal washing towers, all well known to people skilled in the art.

Plastic, ceramic or stainless steel materials are most often recommended in order to prevent or limit the problem of corrosion.

According to a specific embodiment, M represents Na or K.

According to a specific embodiment, R represents chlorine, R¹ represents an OR² group, X represents a hydrogen and n represents 1.

According to a specific embodiment, OR² is an OH or ONa group.

When R represents chlorine, R¹ represents an OH group, X represents a hydrogen and n represents 1, the compound of formula (I) then represents monochloroacetic acid (CAS no. 79-11-8).

When R represents chlorine, R¹ represents an ONa group, X represents a hydrogen and n represents 1, the compound of formula (I) then represents sodium monochloroacetate (CAS no. 3926-62-3).

According to a specific embodiment, the functional volatile organic compound is selected from the volatile organic compounds carrying an amine, amide, nitrile, aldehyde, ketone, ester, carboxylic acid, alcohol, thiol, disulphide, thioester group, halogenated volatile organic compounds, phosgene and hydrocyanic acid.

The volatile aldehydes, in particular in gaseous form, are for example formaldehyde.

The volatile aldehydes, in particular in the form of droplet aerosols, are for example acetaldehyde, butanal, pentanal, hexanal and heptanal.

The volatile ketones, in particular, in the form of droplet aerosols, are for example acetone, methylethylketone, methylisobuthylketone.

The volatile carboxylic acids, in particular in the form of droplet aerosols, are for example formic acid, acetic acid, acrylic acid.

The halogenated volatile organic compounds are for example methyl chloride, dichloromethane, chloroform, carbon tetrachloride, the analogues thereof in C₂ or C₃, chlorofluorocarbons, vinyl chloride, dichlorethylene, trichlorethylene, tetrachlorethylene, dichloroacetylene and allyl chloride.

The volatile alcohols, in particular in the form of droplet aerosols, are for example methanol, ethanol, propanol, butanol and ethylene glycol.

The volatile thiols are for example methanethiol, ethanethiol, 1-propanethiol, 2-propanethiol, ter-butanethiol.

The volatile thioesters are for example methylthioacetate, methylthiobutanoate, methylthiopentanoate.

According to a specific embodiment, step (iii) is followed by a step (iv) of destroying said capture product, in particular in the form of liquid effluents, in particular in a purification plant, more specifically in a biological purification plant, even more specifically via aerobic bio-purification.

In particular, the liquid effluents obtained at the end of the method according to the invention are odourless and colourless.

In the case of a discharge into a collective treatment network provided with a purification plant, the limit discharge values for wastewater are typically as follows:
Suspended matter: 600 mg/l;
Chemical Oxygen Demand (COD): 2000 mg/l;
Biochemical Oxygen Demand, for 5 days (BODS): 800 mg/l.

The method according to the invention is compatible with such regulations, in that said capture product makes it possible to fully comply with these limit values.

Indeed, the method according to the invention makes it possible to obtain a liquid treated product that is absolutely odourless and colourless that can be directly removed to a self-neutralisation basin of a purification plant; in addition, the acidification does not regenerate any mercaptans or hydrogen sulphide.

The biological treatment in a purification plant also does not create any new nuisances, to the treatment network nor to the plant itself.

In fact, the BOD (Biochemical Oxygen Demand) and COD measurements are improved compared to the conventional oxidising destruction methods.

According to a specific embodiment, the quantity in moles of pollutant in the purified composition obtained at the end of step (ii), with respect to the total number of moles of said purified composition, is less than 10%, in particular less than 9, 8, 7, 6, 5, 4, 3, 2, 1, 0.5, 0.1, 0.05, 0.01, 0.005 or 0.001%.

According to another aspect, the invention relates to the use of a compound of general formula (I) such as described above, for purifying a gaseous, liquid or aerosol composition, containing at least one pollutant consisting of:
at least one volatile inorganic compound selected from carbon dioxide, nitrogen monoxide, nitrogen dioxide, halogenhydric acids, thionyl chloride, sulphuryl chloride, ammonia, halogens, hydrogen sulphide, carbon oxysulphide and sulphur dioxide, and/or
at least one siloxane, and/or
at least one functional volatile organic compound,

on the condition that said pollutant does not consist exclusively of hydrogen sulphide, the sulphur dioxide, a functional volatile organic compound carrying a thiol group.

The embodiments presented above relating to the method according to the invention also relate to the use according to the invention.

### Definitions

Such as used in the present description, the term “about” refers to an interval of values that are ±10% of a specific value. As an example, the expression “about 120 mg” includes the values of 120 mg±10%, which are the values from 108 mg to 132 mg.

In terms of the present description, the percentages refer to percentages by weight with respect to the total weight of the formulation, unless mentioned otherwise.

Such as understood here, the value ranges in the form of “x-y” or “from x to y” or “between x and y” include the limits x and y as well as the integers between these limits. As an example, “1-5”, or “from 1 to 5” or “between 1 and 5” designate the integers 1, 2, 3, 4 and 5. The preferred embodiments include each integer taken individually in the value range, as well as any sub-combination of these integers. As an example, the preferred values for “1-5” can comprise the integers 1, 2, 3, 4, 5, 1-2, 1-3, 1-4, 1-5, 2-3, 2-4, 2-5, etc.

The term “gaseous or liquid composition” means in particular a fluid (gas or liquid), for example air, nitrogen, oxygen, methane, butane, propane or mixtures thereof, containing at least one pollutant.

The term “composition in aerosol form” means in particular a set of liquid particles consisting or containing at least one pollutant, in suspension in a gas, for example air, nitrogen oxygen, methane, butane, propane or mixtures thereof.

The term “purified composition” means in particular a composition obtained at the end of step (ii), wherein the quantity in moles of said at least one pollutant is less than 10% with respect to the total number of moles of said purified composition. The term “volatile organic compound” means any chemical compound that has carbon and hydrogen, which can be replaced with other atoms such as halogens, oxygen, phosphorus, sulphur, silicon or nitrogen, and having a saturation vapour pressure greater than 10 Pa in normal conditions of temperature and of pressure, except for carbon oxides and inorganic carbonates and bicarbonates.

The term “functional volatile organic compound” means any VOC that carries at least one functional group. In particular, the functional volatile organic compound is selected from the volatile organic compounds carrying an amine, amide, nitrile, aldehyde, ketone, ester, carboxylic acid, alcohol, thiol, disulphide, thioester group, halogenated volatile organic compounds, phosgene and hydrocyanic acid.

The term “capture product” means the reaction product of the at least one pollutant with said base and/or said compound of formula (I), with this product not being a gas, a volatile inorganic compound (VIC), a VOC, or a siloxane. This is in particular liquid effluents.

The term “on the condition that said pollutant does not consist exclusively of hydrogen sulphide, sulphur dioxide, or a functional volatile organic compound carrying a thiol group” means that the composition cannot contain as the only pollutant hydrogen sulphide, sulphur dioxide, or a functional volatile organic compound carrying a thiol group.

The term “biogas” means a gas produced by the fermentation of organic materials in the absence of oxygen.

The term “siloxane” means a saturated silicon-oxygen hydride with non-branched or branched chains alternating silicon and oxygen (each silicon atom is separated from the closest neighbouring silicon atoms thereof by single oxygen atoms). The general structure of non-branched siloxanes is H₃Si[OSiH₂]ₙOSiH₃. H₃Si[OSiH₂]ₙOSiH[OSiH₂OSiH₃]₂ is an example of a branched siloxane. The hydrocarbyl derivatives, wherein one or more hydrogen atoms are substituted with an aryl, in particular a phenyl, or C₁-C₆ linear or branched allyl chain, in particular a methyl, are also included.

The term “halogenhydric acid” means hydrofluoric acid, hydrochloric acid, hydrobromic acid or hydriodic acid.

The term “optionally substituted” means in particular a group optionally substituted with at least one group selected from among C1 to C6 linear or branched alkyls and halogens.

The term “a group of formula OR² wherein R² represents an alkaline earth metal” means in fact an OR_{1/2}² group wherein R² represents said alkaline earth metal.

### FIGURES

FIG. 1 represents the diagram of a facility able to implement the method object of the example 3.

F e and F s correspond respectively to the gaseous flow at the inlet and to the gaseous flow at the outlet.

R 1 corresponds to the base.

R 2 corresponds to the aqueous solution of the compound of formula (I).

### EXAMPLES

### Example 1: Treatment of the Biogas

100 m³ of biogas coming from the methanisation of sludge of the purification plant is treated (absorption and destruction of the polluting compounds of the methanisation). The 100 m³ of biogas consists of:
70 m³ of pure methane (biomethane) (3.123 moles);
30 m³ (about 60 kg) of carbon dioxide (CO₂) to be removed and valorised (1.338 moles); and
0.4 kg of hydrogen sulphide (H₂S) to be removed (11.76 moles).

Equipment

The equipment used is as follows:
800-litre absorption column (column+reservoir), height: 3 m, base surface: 0.28 m² (diameter 60 cm), packed with plates, demister at the air outlet;
Circulation of the fluids adjustable from 0 to 25 m³/H;
Supply valve of pollutant gaseous effluent adjustable from 0 to 1000 m³/H.

Reagents

The compound of formula (I) is in particular monochloroacetic acid or sodium monochloroacetate.

The quantities of soda and of compound of formula (I) to be used are evaluated below, according:
to the hourly flow rate of the flow of composition to be purified in m³;
the daily treatment duration;
the concentration of the compounds to be captured in mg/m³.

Hourly air flow rate in m3 25.00
Duration of the discharge in hours/day 4.00

| | | | | | Evaluation of the costs | |
|---|---|---|---|---|---|---|
| Pollutant concentration in | Equivalent | Units | Hourly | Daily flow | Price of materials noted | |
| mg/m³ of air | in ppm | mg/m³ | flow in kg | in kg/day | per kg in € (alibaba.com) | |
| Carbon dioxide | 327,141 | 588,720 | 14.72 | 58.87 | Pure reagent | 0.41 |
| Hydrogen sulphide | 2,876 | 4,000 | 0.10 | 0.40 | Pure potash | 0.35 |
| Methylmercaptan | 0 | | 0.00 | 0.00 | Potash at 30% | 0.31 |
| Ethylmercaptan | 0 | | 0.00 | 0.00 | Pure soda | 0.17 |
| Propanethiol 1 or 2 | 0 | | 0.00 | 0.00 | Soda at 30% | 0.22 |
| Sulphur dioxide | 0 | | 0.00 | 0.00 | Javel water 47° | 0.27 |
| Hydrochloric acid | 0 | | 0.00 | 0.00 | | |

| | | | Hourly | Daily |
|---|---|---|---|---|
| | | | cost € | cost € |
| Base required for the neutralisation in kg | | | | |
| (Choice of Soda or Potash) | | | | |
| Sodium hydroxide 30% | 95.31 | 381.23 | 20.97 | 83.87 |
| Pure soda | 28.59 | 114.37 | 4.86 | 19.44 |
| Potassium hydroxide at 30% | 132.28 | 529.11 | 41.01 | 164.02 |
| Pure potash | 39.68 | 158.73 | 13.89 | 55.56 |
| Compound of formula (I) required for the reaction | | | | |
| Dry pure product (in kg) | 1.83 | 7.32 | 0.75 | 3.00 |
| Solution at 40% required (in kg) | 4.57 | 18.29 | 1.31 | 5.25 |
| Equivalences for comparison with the prior art: | | | | |
| Quantities of Javel water 47° Cl required in | 7 | 29 | 1.93 | 7.72 |
| the systems of the prior art | | | | |

The quantities of reagents, as well as those linked to the prior art methods are calculated with the following stoichiometries:

| | Soda or | Compound of | Javel | | | |
|---|---|---|---|---|---|---|
| | potash | formula (I) | 47° | ClO₂ | Ozone | H₂O₂ |
| Pollutant (1 eq.) | (eq.) | (eq.) | (eq.) | (eq) | (eq.) | (eq.) |
| Carbon dioxide | 2.1 | 0.01 | 0 | 0 | 0 | 0 |
| Hydrogen sulphide | 4.2 | 4.2 | 5.2 | 8.5 | 3.2 | 12.0 |
| Methylmercaptan | 1.1 | 1.1 | 8.5 | 8.2 | 4.0 | 8.5 |
| Ethylmercaptan | 1.1 | 1.1 | 8.5 | 8.2 | 4.0 | 8.5 |
| Sulphur dioxide | 2.1 | 2.0 | 2.2 | 2.2 | 2.2 | 2.2 |
| Hydrochloric acid | 1.0 | 0 | 0 | 0 | 0 | 0 |

The corresponding costs, as well as those, for the purposes of comparison, of prior art treatments, are listed in the following table:

| | | | | | | | | | Comparison with the | | | |
|---|---|---|---|---|---|---|---|---|---|---|---|---|
| | | | | | | | | | methods of the prior art | | | |
| | | | kg | kg | kg | kg | kg | kg | Javel | Liquid | Ozone | |
| | | | soda | pure | potash | pure | reagent | pure | water | chlorine | via | Perhydrol |
| Pollutants to be | Molarity | Units | at 30% | soda | at 30% | potash | at 40% | reagent | 47° | dioxide | generator | 30% |
| treated in kg | (in moles) | in kg | Either soda, or potash | | | | By choice | | In kg | In kg | In kg | In kg |
| Carbon dioxide | 1.338.6 | 58.9 | 374.8 | 112.4 | 524.7 | 157.4 | 3.9 | 1.6 | | | | |
| Hydrogen sulphide | 11.8 | 0.4 | 6.6 | 2.0 | 9.2 | 2.8 | 14.4 | 5.8 | 28.6 | 31.9 | 17.6 | 66.0 |
| Methylmercaptan | 0.0 | | 0.0 | 0.0 | 0.0 | 0.0 | 0.0 | 0.0 | 0.0 | 0.0 | 0.0 | 0.0 |
| Ethylmercaptan | 0.0 | | 0.0 | 0.0 | 0.0 | 0.0 | 0.0 | 0.0 | 0.0 | 0.0 | 0.0 | 0.0 |
| Sulphur dioxide | 0.0 | | 0.0 | 0.0 | 0.0 | 0.0 | 0.0 | 0.0 | 0.0 | 0.0 | 0.0 | 0.0 |
| Hydrochloric acid | 0.0 | | 0.0 | 0.0 | 0.0 | 0.0 | 0.0 | | | | | |

| | | | | | Total weight | | | | | |
|---|---|---|---|---|---|---|---|---|---|---|
| | Either soda, or potash. | | | | in kg | | Total in kg according to the | | | |
| | Total in kg | | | | Comp. of | Pure | method used | | | |
| | Soda | Pure | Potash | Pure | form. (I) | comp. of | Javel | | | |
| | at 30% | soda | at 30% | potash | at 40% | form. (I) | 47° | ClO₂ | Ozone | H₂O₂ |
| Sum of the fillers | 381.4 | 114.4 | 534.0 | 160.2 | 18.3 | 7.3 | 28.6 | 31.9 | 17.6 | 66.0 |
| Relative prices in kg | 0.22 | 0.17 | 0.31 | 0.35 | 0.32 | 0.35 | 0.27 | 0.89 | / | 0.41 |
| Estimation of the costs | 83.9 | 19.5 | 165.5 | 56.1 | 5.9 | 2.6 | 7.7 | 28.4 | / | 27.0 |

| Reaction volume of the washer to be supplemented if | 467 |
|---|---|
| necessary (in litres) | |

Thus, the treatment with Javel water is 5 times more expensive than the method according to the invention. The treatments with ClO₂ or H₂O₂ are even more expensive, 10 times more expensive than the method according to the invention.

Operating Procedure

In the wet well, the calculated quantities of alkaline solution of soda or of potash, then the solution at 40% of the compound of formula (I) are filled in order.

The additional water is filled, corresponding to 20 volumes of the pure compound of formula (I).

The reaction medium then displays a value of pH>11.

The circulation pump is activated then the flow rate valve of the gases is progressively released and controlled at the desired flow rate.

The end of the reaction is determined and controlled by pH<9.

The sodium carbonate precipitate is then separated and can be recycled for example in a cement plant.

Results

The results obtained are as follows:
The complete removal of H₂S;
The decarbonation (complete removal of the CO₂);
The removal of 4% of water of the methanisation at 40° C.
The total removal of the siloxanes and organochlorines or fluorines if present in a trace state.

In this example, the method according to the invention made it possible to purify 100 m³ of biogas which supplied 70 m³ of pure biomethane, but also to capture and to remove 30 m³ of carbonic gas and to remove 0.4 kg of H₂S.

The cost of the treatment according to the method of the invention is as follows:
treatment of the 100 m³ of biogas: €0.36 per m³;
for the 30 m³ of CO₂ present and removed: €1.08 per m³.

The treatment of 100 m³ of biogas supplied 70 m³ of biomethane equivalent to 680 kW/h of electricity.

The cost price of the biomethane completely purified according to the method of the invention is €0.054€ per kW/h. The cost price in the competing systems is around €0.15 per kW/h.

### Example 2: Treatment of a Mixture of Pollutants in Industry

Equipment

The equipment used is as follows:
800-litre absorption column (column+reservoir), height: 3 m, base surface: 0.28 m² (diameter 60 cm), packed with plates, demister at the air outlet;
Circulation of the fluids adjustable from 0 to 25 m³/H;
Supply valve of pollutant gaseous effluent adjustable from 0 to 1000 m³/H.

Reagents

The compound of formula (I) is in particular monochloroacetic acid or sodium monochloroacetate.

The composition of the effluent to be treated is given in the following table.

Furthermore, the quantities of soda and of compound of formula (I) to be used are evaluated below, according:
to the hourly flow rate of the flow of composition to be purified in m³;
the daily treatment duration;
the concentration of the compounds to be captured in mg/m³.

Variables in blue to be entered
Hourly air flow rate in m³ 500.00
Duration of the discharge in hours/day 10.00

| | | | | | Evaluation of the costs | |
|---|---|---|---|---|---|---|
| Pollutant concentration in | Equivalent | Units | Hourly | Daily flow | Price of materials noted | |
| mg/m³ of air | in ppm | mg/m³ | flow in kg | in kg/day | per kg in € (alibaba.com) | |
| Carbon dioxide | 288.95 | 520.00 | 0.260 | 2.600 | Pure reagent | 0.41 |
| Hydrogen sulphide | 4.10 | 5.70 | 0.003 | 0.029 | Pure potash | 0.35 |
| Methylmercaptan | 1.07 | 2.10 | 0.001 | 0.011 | Potash at 30% | 0.31 |
| Ethylmercaptan | 49.29 | 125.00 | 0.063 | 0.625 | Pure soda | 0.17 |
| Propanethiol 1 or 2 | 0.00 | | 0.000 | 0.000 | Soda at 30% | 0.22 |
| Sulphur dioxide | 0.27 | 0.70 | 0.000 | 0.004 | Javel water 47° | 0.27 |
| Hydrochloric acid | 1.61 | 2.40 | 0.001 | 0.012 | | |

| | | | Hourly | Daily |
|---|---|---|---|---|
| | | | cost € | cost € |
| Base required for the neutralisation in kg | | | | |
| (Choice of Soda or Potash) | | | | |
| Sodium hydroxide 30% | 1.86 | 18.58 | 0.41 | 4.09 |
| Pure soda | 0.56 | 5.58 | 0.09 | 0.95 |
| Potassium hydroxide at 30% | 2.55 | 25.50 | 0.79 | 7.90 |
| Pure potash | 0.76 | 7.65 | 0.27 | 2.68 |
| Compound of formula (I) required for the reaction | | | | |
| Dry pure product (in kg) | 0.18 | 1.81 | 0.07 | 0.74 |
| Solution at 40% required (in kg) | 0.45 | 4.53 | 0.13 | 1.30 |
| Equivalences for comparison with the prior art: | | | | |
| Quantities of Javel water 47° Cl required in | 4.3 | 43 | 1.16 | 11.60 |
| the systems of the prior art | | | | |

The corresponding costs, as well as those, for the purposes of comparison, of prior art treatments, are listed in the following table:

| | | | | | | | | | Comparison with the | | | |
|---|---|---|---|---|---|---|---|---|---|---|---|---|
| | | | | | | | | | methods of the prior art | | | |
| | | | kg | kg | kg | kg | kg | kg | Javel | Liquid | Ozone | |
| | | | soda | pure | potash | pure | reagent | pure | water | chlorine | via | Perhydrol |
| Pollutants to be | Molarity | Units | at 30% | soda | at 30% | potash | at 40% | reagent | 47° | dioxide | generator | 30% |
| treated in kg | (in moles) | in kg | Either soda, or potash | | | | By choice | | In kg | In kg | In kg | In kg |
| Carbon dioxide | 59.1 | 2.60 | 16.55 | 4.96 | 23.16 | 6.95 | 0.17 | 0.07 | | | | |
| Hydrogen | 0.9 | 0.03 | 0.49 | 0.15 | 0.69 | 0.21 | 1.08 | 0.43 | 2.14 | 2.39 | 1.32 | 4.95 |
| sulphide | | | | | | | | | | | | |
| Methyl- | 0.2 | 0.01 | 0.03 | 0.01 | 0.04 | 0.01 | 0.07 | 0.03 | 0.83 | 0.80 | 0.39 | 0.83 |
| mercaptan | | | | | | | | | | | | |
| Ethylmercaptan | 10.2 | 0.63 | 1.49 | 0.45 | 2.09 | 0.63 | 3.26 | 1.30 | 40.36 | 38.94 | 18.99 | 40.36 |
| Sulphur | 0.2 | 0.01 | 0.04 | 0.01 | 0.06 | 0.02 | 0.09 | 0.04 | 0.32 | 0.32 | 0.29 | 0.32 |
| dioxide | | | | | | | | | | | | |
| Hydrochloric | 0.3 | 0.01 | 0.04 | 0.01 | 0.05 | 0.02 | 0.00 | | | | | |
| acid | | | | | | | | | | | | |

| | | | | | Total weight | | | | | |
|---|---|---|---|---|---|---|---|---|---|---|
| | Either soda, or potash. | | | | in kg | | Total in kg according to | | | |
| | Total in kKg | | | | Comp. of | Pure | the method used | | | |
| | Soda | Pure | Potash | Pure | form. (I) | comp. of | Javel | | | |
| | at 30% | soda | at 30% | potash | at 40% | form. (I) | 47° | ClO₂ | Ozone | H₂O₂ |
| Sum of the fillers | 18.6 | 5.6 | 26.1 | 7.8 | 4.7 | 1.9 | 43.7 | 42.4 | 21.0 | 46.5 |
| Relative prices in kg | 0.22 | 0.17 | 0.31 | 0.35 | 0.32 | 0.35 | 0.27 | 0.89 | / | 0.41 |
| Estimation of the costs | 4.1 | 1.0 | 8.1 | 2.7 | 1.5 | 0.7 | 11.8 | 37.8 | / | 19.0 |

| | |
|---|---|
| Reaction volume of the washer to be supplemented | 25 |
| if necessary (in litres) | |

The calculation of the reaction volume to be supplemented is
calculated in relation to the products at 30% and at 40%

Thus, the treatment with Javel water is 17 times more expensive than the method according to the invention. The treatments with ClO₂ or H₂O₂ are even more expensive.

Operating Procedure

In the wet well, the calculated quantities of alkaline solution of soda or of potash, then the solution at 40% of the compound of formula (I) are filled in order.

The additional water is filled, corresponding to 20 volumes of the pure compound of formula (I).

The reaction medium then displays a value of pH>11.

The circulation pump is activated then the flow rate valve of the gases is progressively released and controlled at the desired flow rate.

The flow rate of the gases is set to 500 m³/h. and the flow rate of the circulation pump of the washing solution to 11 m³/h.

The unit allowed for an operating duration of 10 hours during which regular controls of the effectiveness verified the absence of pollutants at the outlet of the facility.

The end of the reaction is determined and controlled by pH<9.

The sodium carbonate precipitate is then separated and can be recycled for example in a cement plant.

Optionally, the sodium carbonate can then advantageously be displaced by calcium chloride to obtain calcium carbonate, practically insoluble, according to the reaction:

Na₂CO₃+CaCl₂ CaCO₃+2 NaCl

Results

The results obtained are as follows:
The removal of the sulphur compounds;
The decarbonation (complete removal of the CO₂);
The elimination of the hydrochloric acid.

Furthermore, the capture product (the filtered reaction medium, before discharge) is such that:
pH=8.3;
temperature <30° C.,
DCO: 287 mg/l;
DBO₅: 670 mg/l.

### Example 3: Continuous Treatment of a Source of Biogas Containing a Mixture of Pollutants in Order to Obtain Purified Biomethane

Equipment

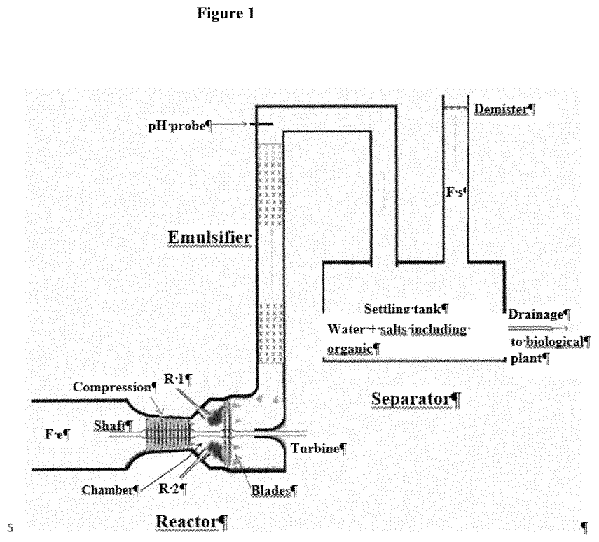

The equipment used comprises of the following elements (FIG. 1):
A storage tank for the alkaline solution of soda or of potash;
A storage tank for the solution of the compound of formula (I);
A “reactor” turbine comprising a compressor, a vaporisation/reaction chamber and a blade turbine;
Two mist nozzles each supplied by a metering pump controlled for the inlet gas flow rate and controlled for pH;
An “emulsifier” column (diameter 60 cm) with inside packing and pH control probe;
A “recovery” column with gravity flow (diameter 60 cm) with the outlet of the purified methane comprising a demister;
A separation tray (volume 800 litres) with an overflow;
A buffer tank for the collection of the washing water for control before discharge to the biological purification plant.

Reagents

The compound of formula (I) is in particular monochloroacetic acid or sodium monochloroacetate.

The composition of the effluent to be treated is given below for an average flow rate of 500 m³/h.:
Methane: 85.2% (426 m³)
Air: 7% (35 m³)
CO₂: 4.8% (24 m³, that is 45 kg)
Various impurities: 2.8% including:
H₂S: 10618 mg/m³
Mercaptans: 207 mg/m³

(ethanethiol, methanethiol, propanethiol and butanetiol)
Ketones: 198 mg/m³

(acetone, 2-butanone)
Siloxanes: 140 mg/m³

(trimethyl silanol, tetramethylsilane, siloxane D4)
Alcohols: 71 mg/m³

(propanol, butanol, pentanol, isopropylalcohol)
Halogens: 35 mg/m³

(di, tri and tetra chloroethylene).

Furthermore, the quantities of soda and of compound of formula (I) to be used are evaluated below, according:
to the hourly flow rate of the flow of composition to be purified in m³;
the daily treatment duration;
the concentration of the compounds to be captured in mg/m³.

Sodium hydroxide at 30%: 331 kg/h.

Solution at 40% of the compound of formula (I): 195 kg/h (expressed as sodium monochloroacetate).

Operating Procedure

In a storage tank, there is the alkaline solution of soda or of potash.

In another storage tank, there is the 40% solution at of the compound of formula (I).

The average flow rate of the inlet flow measured is 500 m³/h. (8333 litres/minute) and the flow rate of the metering pumps of the washing solution is adjusted as follows according to this inlet flow rate of gases
Alkaline solution: 5.52 ml/minute
Solution of formula (I): 3.25 ml/minute

These two metering pumps are controlled on the one hand for the gaseous flow rate and on the other hand for the pH probe which must be between 9 and 11.5 (measurement taken on the emulsifier).

The washing water is continuously drained to the buffer collection tray for correction of the pH if necessary.

A control of the parameters is carried out before discharge to the biological purification plant.
pH=8.3;
temperature <30° C.,
DCO: 287 mg/l;
DBO₅: 670 mg/l.

Results

The unit has made it possible for a continuous operation during which regular controls of the effectiveness verified the absence of pollutants at the outlet of the facility.

The purification results of the biomethane obtained are as follows:
Purification of 426 m³/h. of biomethane (7100 litres/minute);
The removal of sulphur compounds;
The decarbonation (complete removal of the CO₂);
The removal of the various impurities identified.

1. A method for purifying a gaseous, liquid or aerosol composition, containing at least one pollutant consisting of:
at least one volatile inorganic compound selected from carbon dioxide, nitrogen monoxide, nitrogen dioxide, halogenhydric acids, thionyl chloride, sulphuryl chloride, ammonia, halogens, hydrogen sulphide, carbon oxysulphide and sulphur dioxide, and/or
at least one siloxane, and/or
at least one functional volatile organic compound,
said method comprising the following steps:
(i) the alkalinisation of said composition to a pH>11 in the presence of a base of general formula M-OH, wherein M represents an alkaline metal,
(ii) the putting into contact of the product obtained in (i) with a compound of general formula (I):
R—[CH(—X)]ₙ—CO—R¹ (I),
wherein:
R represents:
a sulfonyl halide of formula X′—SO₂—R′, wherein X′ represents a halogen, and R′ represents a C₁-C₂₀ alkyl group or an optionally substituted aryl group,
a halogen, or
an OH group,
X represents:
a halogen,
an OH group,
a hydrogen, or
a COOH group,
R¹ represents:
a C₁-C₁₆ alkoxy,
a group of formula NH—R″, wherein R″ represents a hydrogen atom or a C₁-C₂₀ alkyl group,
a group of formula OR² wherein R² represents a hydrogen atom, an alkaline metal, an alkaline earth metal or an ammonium group, or
a halogen,
n represents 1, 2, 3 or 4;
to obtain a purified composition, as well as a capture product resulting from the reaction of the at least one pollutant with said base and/or said compound of formula (I);
(iii) the separation of said purified composition from said capture product;
with the condition that said pollutant does not consist exclusively of hydrogen sulphide, sulphur dioxide, or a functional volatile organic compound carrying a thiol group.

2. The method according to claim 1, wherein said composition contains carbon dioxide and at least one other pollutant consisting of:
at least one volatile inorganic compound selected from nitrogen monoxide, nitrogen dioxide, halogenhydric acids, thionyl chloride, sulphuryl chloride, ammonia, halogens, hydrogen sulphide, carbon oxysulphide and sulphur dioxide, and/or
at least one siloxane, and/or
at least one functional volatile organic compound,
said method comprising the following steps:
(i) the alkalinisation of said composition to a pH>11 in the presence of a base of general formula M-OH such as defined in claim 1,
(ii) the putting into contact of the product obtained in (i) with a compound of general formula (I) such as defined in claim 1,
to obtain a purified composition, as well as a capture product resulting from the reaction of the carbon dioxide and of the at least one other pollutant with the base and/or the compound of formula (I); and
(iii) the separation of said purified and dry product from said capture product.

3. The method according to claim 2, wherein said composition is a biogas.

4. The method according to claim 2, wherein said capture product is comprised of a first capture product resulting from the reaction of the carbon dioxide with the base, and of a second capture product resulting from the reaction of the at least one other pollutant with the base and/or the compound of formula (I),
the first capture product being in particular separated from the second capture product coming from step (iii),
the first capture product being more specifically placed into contact, after said separation, with calcium chloride to form calcium carbonate.

5. The method according to claim 1, wherein said composition is an effluent.

6. The method according to claim 1, wherein steps (i) and (ii) are carried out simultaneously.

7. The method according to claim 1, wherein steps (i) and (ii) are carried out in a washing tower, in particular in one single washing tower.

8. The method according to claim 1, wherein:
M represents Na or K, and/or
R represents chlorine, R¹ represents an OR² group, X represents a hydrogen and n represents 1, and/or
OR² is an OH or ONa group.

9. The method according to claim 1, wherein the functional volatile organic compound is selected from the volatile organic compounds carrying an amine, amide, nitrile, aldehyde, ketone, ester, carboxylic acid, alcohol, thiol, disulphide, thioester group, halogenated volatile organic compounds, phosgene and hydrocyanic acid.

10. The method according to claim 1, wherein step (iii) is followed by a step (iv) of destroying said capture product, in particular in a purification plant, more specifically by aerobic bio-purification.

11. The method according to claim 1, wherein the quantity in moles of pollutant in the purified composition obtained at the end of step (ii) is less than 10%, with respect to the total number of moles of said purified composition.

12. (canceled)
